(19) United States
(12) Patent Application Publication
(10) Pub. No.: US 2026/0253915 A1
(43) Pub. Date: Aug. 27, 2026

(54) HYDROCARBON-BASED MEMBRANE FOR SODIUM POLYSULFIDE BATTERIES

(71) Applicant: UT-Battelle, LLC, Oak Ridge, TN (US)

(72) Inventors: Michelle Lehmann, Knoxville, TN (US); Guang Yang, Knoxville, TN (US)

(21) Appl. No.: 19/545,296

(22) Filed: Feb. 20, 2026

Related U.S. Application Data
(60) Provisional application No. 63/761,690, filed on Feb. 21, 2025.

(51) Int. Cl. H01M 8/0239; H01M 8/0226; H01M 8/18

(52) U.S. Cl. CPC H01M 8/0239; H01M 8/0226; H01M 8/188; H01M 2300/0028

(57) ABSTRACT

A hydrocarbon-based membrane material composition for a redox flow battery includes component A that is a polymer including an anionic group selected from a group consisting of a sulfonylimide moiety, a tetrahedral borate-based moiety, and a carboxylate-based moiety. The composition further includes component B that is a polymer including a sulfonate moiety. The content of component A is 60 to 100 wt. % based on the total weight of components A and B. The content of component B is 0 to 40 wt. % based on the total weight of components A and B. Components A and B may be block copolymers such as pentablock terpolymers. The sulfonylimide moiety may be (trifluoromethanesulfonyl)imide. A method of making a hydrocarbon-based membrane for a redox flow battery and a redox flow battery including the hydrocarbon-based membrane are also provided. The redox flow battery may be a non-aqueous Na—S flow battery.

### CROSS-REFERENCE TO RELATED APPLICATIONS

This application claims the benefit of U.S. Provisional Application No. 63/761,690, filed Feb. 21, 2025, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to membrane materials for non-aqueous redox flow batteries, and more particularly membrane materials for sodium polysulfide redox flow batteries and other applications.

### BACKGROUND OF THE INVENTION

Long-duration energy storage (LDES) technologies are essential for enabling the widespread adoption of renewable energy sources such as wind and solar on the electric grid. Redox flow batteries (RFBs) have emerged as an ideal solution for LDES applications due to their unique capability of decoupling energy density from power density. RFBs operate by circulating electrolytes, namely a catholyte and an anolyte, through a cell stack in which chemical energy is exchanged between the electrolytes across a membrane that separates the battery cell into a catholyte side and an anolyte side. However, current RFB technology primarily uses vanadium or other platinum group metals, which are expensive and cost prohibitive to scale.

Non-aqueous RFBs (NARFBs) offer a promising alternative as they utilize electrolytes with wider operating voltage windows (>3 V) and diverse redox couples. Of particular interest is a hybrid NARFB, which combines an alkali metal anode, such as sodium, with a polysulfide catholyte, mirroring secondary Na—S batteries. Sodium polysulfides (Na₂Sₓ, 2≤x≤8) are promising catholyte materials for nonaqueous RFBs due to their low cost and room temperature operation. However, challenges such as polysulfide shuttling are exacerbated in these NARFB systems due to the need to keep the sodium-sulfur complex in the soluble regime (Na₂Sₓ, x=5-8).

Ceramic membranes, such as Na⁺β″—Al₂O₃, have been widely utilized in polysulfide-based flow batteries due to their ability to eliminate the crossover of catholyte species. However, they are typically only available in thick formats (e.g., 1 mm thick sheets), likely due to their fragile mechanical properties. Porous separators are also commonly used for NARFBs due to being inexpensive and chemically stable. However, their large pores result in significant crossover of soluble polysulfide species.

Therefore, a need continues to exist for improved membranes that exhibit robust mechanical properties, excellent electrochemical stability, high ionic conductivity, and low polysulfide permeability.

### SUMMARY OF THE INVENTION

A hydrocarbon-based membrane material composition for a redox flow battery is provided. The hydrocarbon-based membrane material composition includes component A that is a polymer including an anionic group selected from a group consisting of a sulfonylimide moiety, a tetrahedral borate-based moiety, and a carboxylate-based moiety. The composition further includes component B that is a polymer including a sulfonate moiety. The content of component A is 60 to 100 wt. % based on the total weight of components A and B. The content of component B is 0 to 40 wt. % based on the total weight of components A and B.

In specific embodiments, the content of component A is 90 to 100 wt. % based on the total weight of components A and B, and the content of component B is 0 to 10 wt. % based on the total weight of components A and B.

In specific embodiments, component A is a block copolymer and component B is a block copolymer.

In particular embodiments, i) the block copolymer of component A is a pentablock terpolymer; ii) the block copolymer of component B is a pentablock terpolymer; or iii) both i) and ii).

In certain embodiments, the pentablock terpolymer of component A is poly(t-butylstyrene-b-hydrogenated isoprene-b-sulfonylimide styrene-b-hydrogenated isoprene-b-t-butylstyrene).

In certain embodiments, the pentablock terpolymer of component B is poly(t-butylstyrene-b-hydrogenated isoprene-b-sulfonated styrene-b-hydrogenated isoprene-b-t-butylstyrene).

In specific embodiments, component A includes a sulfonylimide that is (trifluoromethanesulfonyl)imide.

A method of making a hydrocarbon-based membrane for a redox flow battery is also provided. The method includes dissolving the hydrocarbon-based membrane material composition according to any of the embodiments above in a solvent to obtain a mixture. The method further includes tape casting the mixture on a substrate to obtain a tape-casted product. The method further includes annealing the tape-casted product to obtain an annealed product. The method further includes soaking the annealed product in an aqueous base.

In specific embodiments, the block copolymers of components A and B are crosslinked in the annealed product.

In specific embodiments, annealing is performed at a temperature in a range of from 100 to 140° C.

In specific embodiments, the solvent is a mixture of toluene and 1-propanol.

In particular embodiments, toluene and 1-propanol are mixed at a ratio in a range of from 1:0 to 1:1 by weight.

In specific embodiments, the base includes one of a sodium cation and a lithium cation.

A redox flow battery is also provided. The redox flow battery includes the hydrocarbon-based membrane according to any of the embodiments above.

In specific embodiments, the battery is a non-aqueous Na—S flow battery.

In specific embodiments, the battery further includes an electrolyte that includes a glyme-based solvent.

In particular embodiments, the glyme-based solvent includes one or more of a monoglyme, a diglyme, a triglyme, and a tetraglyme.

In particular embodiments, the battery further includes at least one sodium-containing salt dispersed within the glyme-based solvent.

In certain embodiments, the sodium-containing salt includes one or more of sodium hexafluorophosphate, sodium bis(trifluoromethanesulfonyl)imide, sodium bis(fluorosulfonyl)imide, sodium perchlorate, and sodium nitrate.

These and other features of the invention will be more fully understood and appreciated by reference to the description of the embodiments and the drawings.

### BRIEF DESCRIPTION OF THE DRAWINGS

FIG. 1 is a schematic view of components of a hydrocarbon-based membrane material composition in accordance with embodiments of the disclosure;

FIG. 2 is a schematic view of a nonaqueous redox flow battery (RFB) in accordance with embodiments of the disclosure;

FIG. 3 is a graph of dynamic mechanical analysis (DMA) of membranes formed with Component B of the composition and Example 1 of the examples;

FIG. 4 is a graph of dynamic mechanical analysis of Examples 1-4;

FIG. 5 is a graph of electrolyte uptake and ionic conductivity (at 30° C.) for Examples 1-4 and the Comparative Example;

FIG. 6 is a graph of ionic conductivity as a function of temperature for Examples 1-4;

FIG. 7 is a graph illustrating open circuit voltage evolution of full cells including the membranes of Examples 1 and 2 and the Comparative Example;

FIG. 8 is a graph of galvanostatic cycling profiles of the second, twentieth, and fiftieth cycles of full cells including the membranes of Examples 1 and 2 and the Comparative Example, cycled at 0.2C (330 mA/cm²) and room temperature;

FIG. 9 is a graph of cycling stability of full cells including the membranes of Examples 1 and 2 and the Comparative Example cycled at 0.2C (330 mA/cm²) and room temperature; and

FIG. 10 is a graph of differential capacity profiles of the second and fiftieth cycles of full cells including the membranes of Examples 1 and 2 and the Comparative Example.

### DETAILED DESCRIPTION OF THE CURRENT EMBODIMENTS

A hydrocarbon-based membrane material composition for a redox flow battery, a method of making a hydrocarbon-based membrane for a redox flow battery, and a redox flow battery including the hydrocarbon-based membrane are disclosed herein. The hydrocarbon-based membrane composition includes a blend of two polymer components that are subsequently crosslinked by annealing. Membranes formed of the composition of the present embodiments demonstrated improved electrochemical stability against sodium metal and lower polysulfide crossover compared to a PFAS-based (perfluoroalkyl substances) membrane. The membranes of the present embodiments also exhibited improved capacity retention in a Na—NaₛSₓ battery compared to the PFAS-based membrane. The membranes of the present embodiments thus may be useful as high-performance membranes for redox flow batteries containing an alkali metal anode to meet long-duration energy storage demands.

The hydrocarbon-based membrane material composition includes a Component A and a Component B. Each of Components A and B are polymers, and in various embodiments Components A and B are block copolymers. The polymers of Components A and B are hydrocarbon-based polymers, which as used herein is intended to mean polymers that are free of fluorinated groups such as fluoroalkyl groups. Thus, the hydrocarbon-based membrane material composition is free or essentially free of PFAS-based components (per- and polyfluoroalkyl substances). The content of component A in the composition is in a range of from approximately 60 to 100 percent by weight (wt. %) based on the total weight of components A and B, optionally from 60 to less than 100 wt. %, optionally from 65 to 100 wt. %, optionally from 70 to 100 wt. %, optionally from 75 to 100 wt. %, optionally from 80 to 100 wt. %, optionally from 85 to 100 wt. %, optionally from 90 to 100 wt. %, optionally from 95 to 100 wt. %. The content of component B in the composition is in a range of from approximately 0 to 40 wt. % based on the total weight of components A and B, from greater than 0 to 40 wt. %, optionally from 0 to 35 wt. %, optionally from 0 to 30 wt. %, optionally from 0 to 25 wt. %, optionally from 0 to 20 wt. % optionally from 0 to 15 wt. %, optionally from 0 to 10 wt. %, optionally from 0 to 5 wt. %.

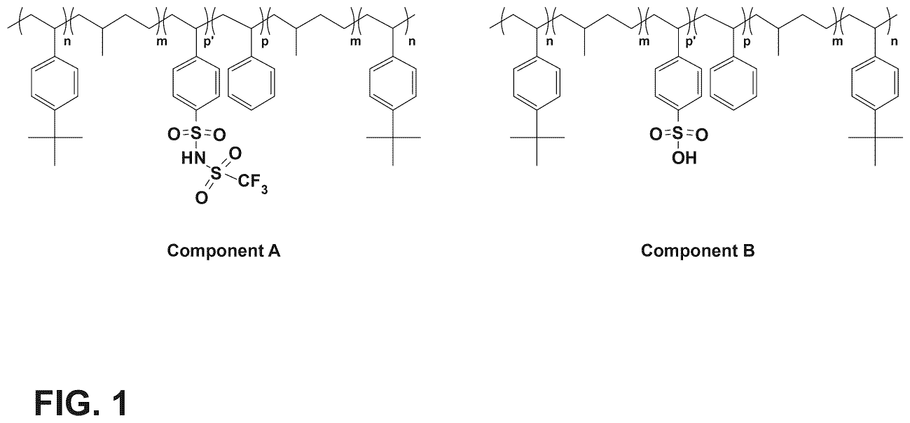

In some embodiments, either or both of Components A and B is/are pentablock terpolymers. Further, Component A may include a sulfonylimide that is (trifluoromethanesulfonyl)imide (TFSI). In exemplary embodiments, Component A is poly(t-butylstyrene-b-hydrogenated isoprene-b-sulfonylimide styrene-b-hydrogenated isoprene-b-t-butylstyrene), and Component B is poly(t-butylstyrene-b-hydrogenated isoprene-b-sulfonated styrene-b-hydrogenated isoprene-b-t-butylstyrene). Chemical structures for the repeating units of these exemplary pentablock terpolymers for Component A and Component B are shown in FIG. 1, wherein n, m, p, and p′ are integers representing the number of repeating units.

Component B combines a rigid poly(t-butyl styrene) outer block for mechanical support, a flexible low T_{g} poly(ethylene-r-propylene) inner block, and a sulfonated polystyrene ionic center block. In addition to providing mechanical rigidity, the t-butyl styrene structure also prevents sulfonation of the outer block, thereby permitting selective sulfonation of the center block. Component A may be formed by converting the sulfonic acid group of component B to a TFSI function group. The conversion may, for example, be performed via a two-step process. In this process, the polymer is reacted with thionyl chloride to form a sulfonyl chloride intermediate. The sulfonyl chloride intermediate is then reacted with trifluoromethanesulfonamide (TFSA) and triethylamine (TEA) to form the styrene TFSI functional group.

The hydrocarbon-based membrane material composition may further include a solvent or solvents in which the polymer Components A and B are dissolved. For example, the solvent may include one or more of toluene, 1-propanol, tetrahydrofuran, and cyclohexane. In some embodiments, the solvent is a mixture of toluene and 1-propanol, and the toluene and 1-propanol components may be mixed in a ratio of from 1:0 to 1:1 by weight. However, it should be understood that other solvent blends may be utilized within the scope of the disclosure. The solution of polymer components in the solvent(s) may have a content of polymer components in a range of from 10 to 20 wt. % based on the total weight of the solution, optionally from 10 to 15 wt. %, optionally from 15 to 20 wt. %, optionally from 12 to 18 wt. %, optionally from 12 to 14 wt. %.

In various embodiments, the method of making a hydrocarbon-based membrane includes dissolving the hydrocarbon-based membrane material composition in one or more solvents to obtain a mixture that is a solution of the polymer components of the composition in the solvent(s) as described above. Next, the solution is cast onto a substrate such as by tape-casting or similar to obtain a casted product. The casted product is then annealed to obtain an annealed product. The step of annealing may be performed at a temperature in a range of from 100 to 140° C., optionally from 105 to 135° C., optionally from 110 to 130° C., optionally from 115 to 125° C. The step of annealing may be performed for a time period of at least 15 minutes, optionally at least 30 minutes, optionally at least 1 hour. In the annealed product, the polymer Components A and B may be crosslinked. Subsequent to annealing, the annealed product is soaked in an aqueous base, such as, for example, a base that includes a sodium cation or a lithium cation. In exemplary embodiments, the aqueous base is NaOH or LiOH. The sodium cations or lithium cations of the aqueous base replace the protons (H⁺) in the moieties of Components A and B. After soaking in the aqueous base, the cation-exchanged product may be rinsed with deionized water, cut into a desired size and shape, and dried (at an elevated temperature and/or under vacuum) to obtain the membrane.

In various embodiments, the membrane obtained from the hydrocarbon-based membrane material composition and method described above may be used as the membrane of a redox flow battery (RFB), such as a sodium-based or lithium-based flow battery. In exemplary embodiments, the redox flow battery including the membrane is a non-aqueous Na—S flow battery.

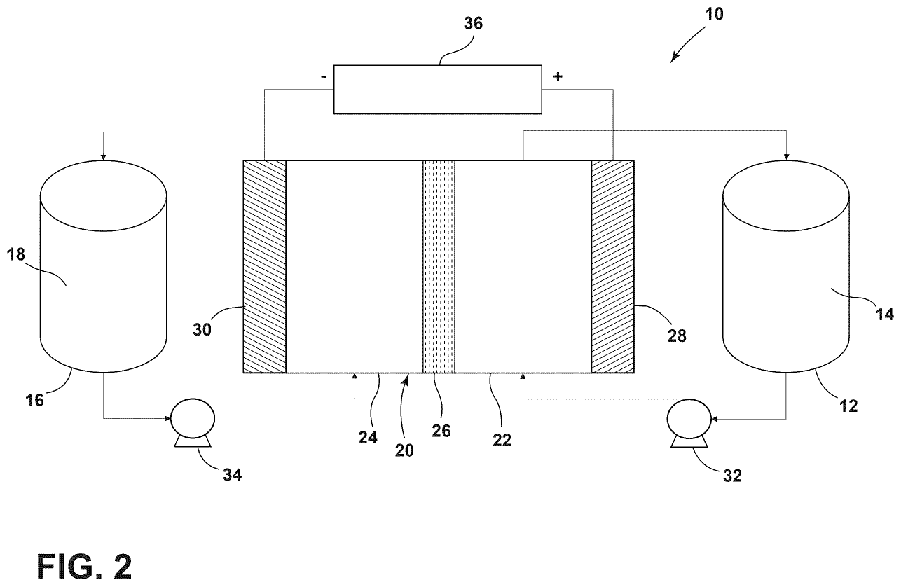

With reference to FIG. 2, a nonaqueous RFB is generally shown at 10. The RFB 10 includes a positive electrolyte reservoir 12 containing a catholyte material 14 and negative electrolyte reservoir 16 containing an anolyte material 18. The RFB 10 further includes a cell 20 including a catholyte side 22 and an anolyte side 24 separated by an ion exchange membrane 26. The positive electrolyte reservoir 12 is fluidly connected to the catholyte side 22 of the cell 20, and the negative electrolyte reservoir 16 is fluidly connected to the anolyte side 24 of the cell 20. A current collector in the form of a cathode 28 is adjacent the catholyte side 22 and a current collector in the form of an anode 30 is adjacent the anolyte side 24, such that the cathode 28 and anode 30 sandwich the catholyte side 22 and anolyte side 24. The catholyte material 14 is circulated through the catholyte side 22 to and from the positive electrolyte reservoir 12 by a pump 32, and the anolyte material 18 is circulated through the anolyte side 24 to and from the negative electrolyte reservoir 16 by a pump 34. The flow of catholyte material 14 and anolyte material 18 through the cell 20 causes a reaction in which ions are transferred between the catholyte side 22 and the anolyte side 24 through the ion exchange membrane 26 during a charging or discharging cycle. Simultaneously with the ion transfer, electrical energy flows through a power source or load (depending on whether the cell 20 is charging or discharging) designated at 36 that is electrically connected to the cathode 28 and anode 30. In various embodiments, the ion exchange membrane 26 includes the hydrocarbon-based membrane described above.

The electrolyte, e.g. the catholyte material 14 or the anolyte material 18, may include a glyme-based solvent such as one or more of a monoglyme, a diglyme, a triglyme, and a tetraglyme. By way of non-limiting example, the monoglyme may be dimethoxyethane, the diglyme may be is (2-methoxyethyl) ether, the triglyme may be 1,2-bis(2-methoxyethoxy)ethane, and the tetraglyme may be bis[2-(2-methoxyethoxy)ethyl]ether. In the case of a sodium-based RFB, at least one sodium-containing salt dispersed within the glyme-based solvent. By way of non-limiting example, the sodium-containing salt may include one or more of sodium hexafluorophosphate, sodium bis(trifluoromethanesulfonyl)imide, sodium bis(fluorosulfonyl)imide, sodium perchlorate, and sodium nitrate.

In other exemplary embodiments, hydrocarbon-based membrane may be used in a hybrid redox flow battery. Such a hybrid redox flow battery may include one side (e.g., the negative, or anolyte, side) the contains a solid alkali metal, for example sodium or lithium. The other side of the battery (e.g., the positive, or catholyte, side) may contain a liquid electrolyte (catholyte) which can be stored in a tank and circulated through the catholyte side of the battery. Thus, the hybrid redox flow battery may include both a flowing and non-flowing electrolyte.

### EXAMPLES

The present method is further described in connection with the following laboratory examples, which are intended to be non-limiting.

A pentablock terpolymer, poly(t-butylstyrene-b-hydrogenated isoprene-b-sulfonated styrene-b-hydrogenated isoprene-b-t-butylstyrene) (poly(tBS-HI-sS-HI-tBS), Nexar™ MD-9200 obtained from Kraton Corporation) was utilized as Component B. The polymer is synthesized by anionic polymerization followed by hydrogenation of the poly(isoprene) block and selective sulfonation of styrene to obtain an ion exchange capacity (IEC) of 2.0 meq/g. The molecular weight of each block in unsulfonated form (tBS-HI-S-HI-tBS) is approximately 15-10-28-10-15 kg/mol. Component A was synthesized by exchanging the sulfonic acid moieties of Component B with (trifluoromethanesulfonyl)imide (TFSI) moieties. The ion exchange capacity of Component A is 1.6 meq/g. Component A may be referred to as the TFSI form of the block copolymer while Component B may be referred to as the sulfonic acid form of the block copolymer. Various weight ratios of Component A and Component B in proton form were dissolved in a mixture of 1:1 (w/w) of toluene and 1-propanol to form 13 wt. % polymer solutions shown in Table 1.

TABLE 1
Block Copolymer Compositions

| Sample | Component A (wt. %) | Component B (wt. %) |
|---|---|---|
| Example 1 (TFSI 100) | 100 | 0 |
| Example 2 (TFSI 90) | 90 | 10 |
| Example 3 (TFSI 80) | 80 | 20 |
| Example 4 (TFSI 60) | 60 | 40 |

Membranes were fabricated by tape casting the polymer solutions onto silicon coated mylar, air drying overnight, followed by annealing at 120° C. for 30 minutes. The membranes were exchanged from proton to sodium form by soaking in a 1 M NaOH aqueous solution for 24 hours. The NaOH solution was replaced with fresh NaOH three times then rinsed with deionized water. After air-drying for 24 hours, the membranes were cut to size and dried at 85° C. under vacuum before being transferred to an argon filled glovebox. The membranes had a thickness of approximately 50 μm.

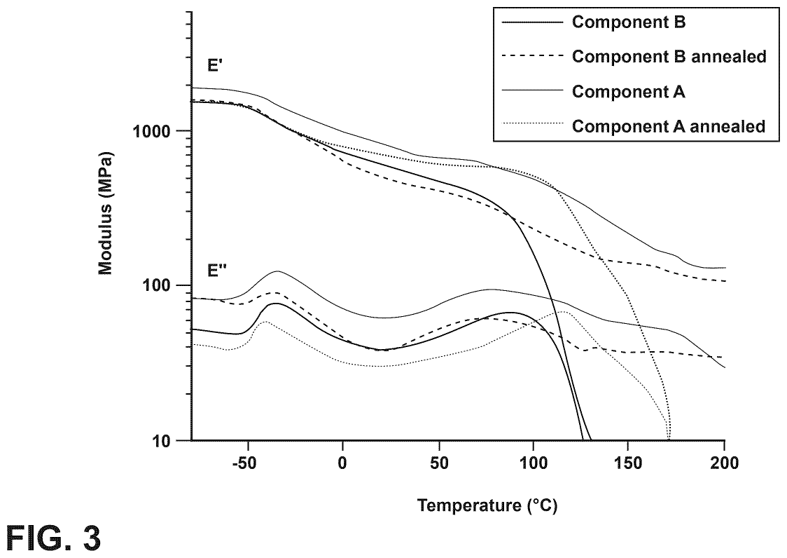

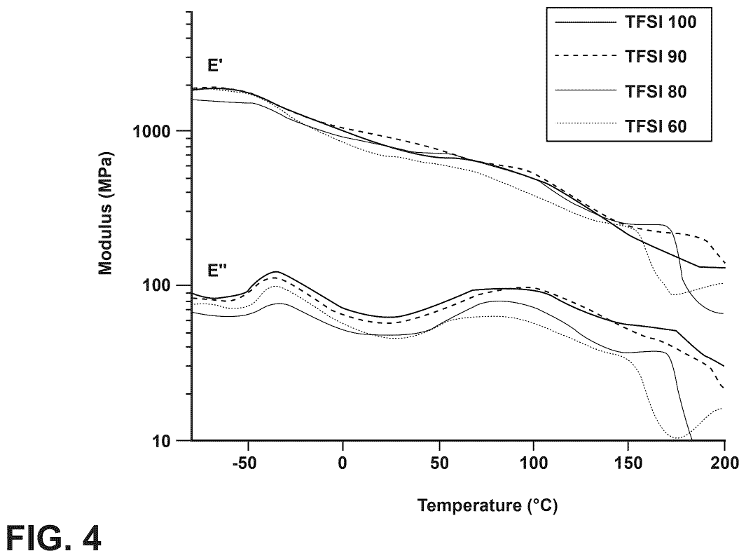

The glass transition temperature (T_{g}) of the membranes was determined by dynamic mechanical analysis (DMA) using a TA Instruments Q800 DMA. Samples having a size of 15×5 mm were measured at an operating frequency of 1 Hz and heated at a rate of 10° C./min from −80 to 250° C. T_{g} of the membranes was recorded from the loss modulus peaks. Successful crosslinking of the membranes was demonstrated by DMA. The membranes were tested in proton form due to the sodium form of the membranes having strong ionic interactions, which increases the T_{g} of the ionic block to temperatures close to the decomposition temperature of the polymers (>450° C.) and thus would obscure the influence of crosslinking. As shown in FIG. 3, the unannealed TFSI (Component A) and sulfonic acid (Component B) forms of the membranes exhibited a softening point at 115° C. and 90° C., respectively, corresponding to the glass transition temperature of polystyrene TFSI and polystyrene sulfonic acid. Upon annealing, both samples exhibited an extended plateau above their respective glass transition temperatures and no crossover point between E′ and E″, indicating either covalent or physical crosslinking occurred to enable the membranes to stay in a solid amorphous state. As shown in FIG. 4, the Component A/Component B blends have a similar E′ and E″ profile as the annealed Component A sample. The TFSI 60 sample exhibited a broader transition between 6° and 120° C., similar to the annealed Component B membrane.

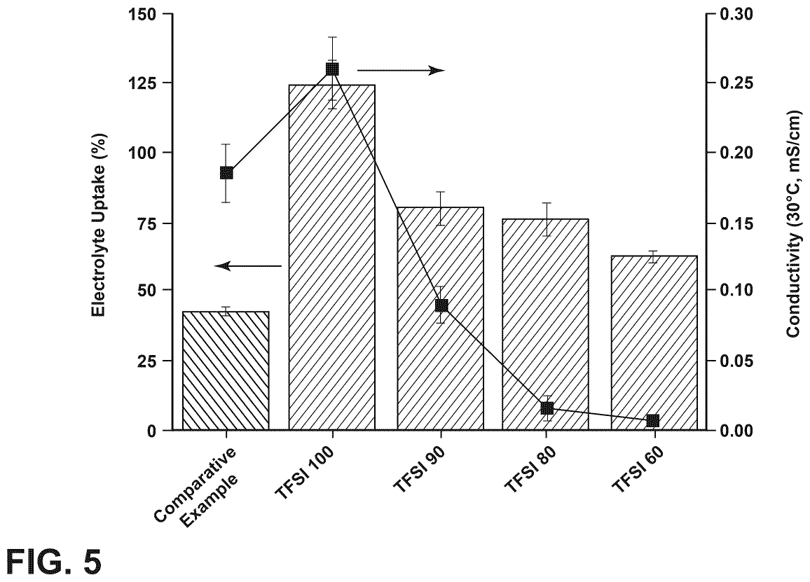

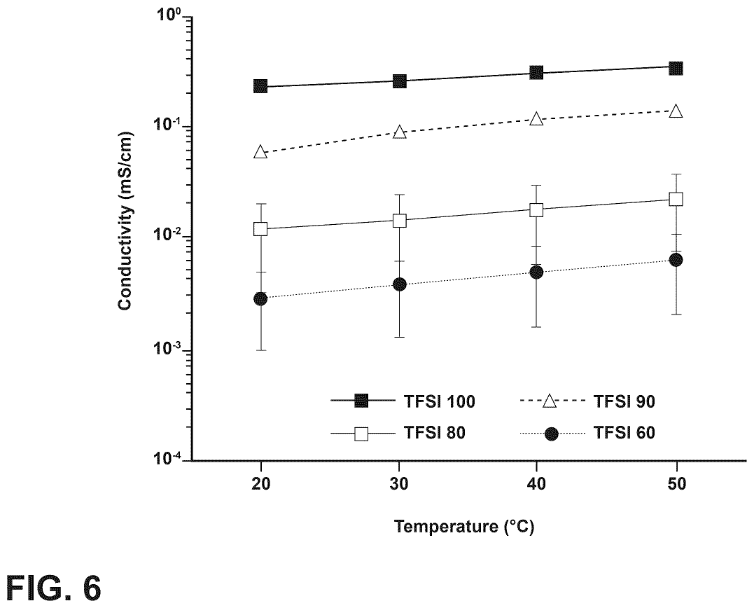

The electrolyte uptake of the membranes soaked in a 1 M NaPF₆/diglyme electrolyte solution was determined by the following Equation (1):

$$Uptake ( \% ) = \frac{{m}_{w} - {m}_{d}}{{m}_{d}} \times 100 \qquad ( 1 )$$

where m_{w} is the mass of the polymer after soaking in the electrolyte solution for at least 48 hours and m_{d} is the mass of the dry polymer. The electrolyte uptake of the membranes influences membrane mechanical properties, conductivity, and redox species permeability. As shown in FIG. 5, the electrolyte uptake decreased with an increase in the content of Component B. The membrane of Example 1 (TFSI 100) had the highest electrolyte uptake of 124%, but lower than the unannealed version (not shown in the graph) which had an electrolyte uptake of 156% in a similar solvent/salt system. The addition of Component B decreased the electrolyte uptake decreases to 80% in Example 2 (TFSI 90), while further addition of Component B in Example 3 (TFSI 80) and Example 4 (TFSI 60) had a limited further influence on electrolyte uptake. Nafion™ (sulfonated tetrafluoroethylene based fluoropolymer-copolymer; Chemours) was used as a Comparative Example and had an electrolyte uptake of approximately 40%. The swelling ratio of the membranes (linear dimensional change) did not change significantly from TFSI 100 (16.1%) to TFSI 90 (15.4%); however, the thickness change of the membranes decreased from 35% to 22%, respectively. The ionic conductivity of the samples is shown in FIG. 6. The ionic conductivity was influenced by the amount of Component B in the membranes. Particularly, the conductivity decreased from 0.25 mS/cm to 5.4×10⁻³ mS/cm for Example 1 (TFSI 100) and Example 4 (TFSI 60) membranes, respectively. On the other hand, the IEC of the membranes increased with the increase in the content of Component B in the blend, from 1.58 to 1.76 mmeq/g for the TFSI 100 and TFSI 60, respectively. The reduction in ionic conductivity with increasing Component B content contrasted with the increase in membrane IEC and indicated that the annealed Component B polymer actually inhibits ionic conductivity in a non-aqueous electrolyte.

Critical current density measurements were conducted at room temperature in sodium symmetric cells in order to determine the maximum operating current density of the membranes. Samples for electrochemical measurements were prepared in a glovebox and equilibrated in the electrolyte solution for at least 48 hours. The samples were sealed in a CR2032 coin cell and sandwiched between 12 mm Na foil. The impedance was measured while heating from 20 to 60° C. for 2 cycles. A frequency range of 1 MHz to 1 Hz was used, with a 6 mV AC signal. Sodium stripping/plating tests were performed at room temperature at ±100 μA/cm² for 0.5 hour in each half cycle. Critical current density measurements were performed at current densities from ±50 to 800 μA/cm² for 0.5 hour in each half cycle. Open circuit voltage and full cell cycling measurements were performed using CR2032 cells containing a 0.95 cm diameter carbon paper containing 11 μL of catholyte and a 12 mm sodium metal anode. The membrane (equilibrated in 1M NaPF₆/diglyme) was blotted to remove excess electrolyte and then assembled in a cell containing catholyte-soaked carbon paper and sodium metal. Open circuit voltage measurements used a 0.25 M Na₂S₈ in 0.5 M NaPF₆/diglyme catholyte. Full cell cycling measurements utilized a 0.25 M Na₂S₈ in 1 M NaPF₆ 0.2 M NaNO₃/5:1 tetraglyme:diglyme (v/v) catholyte and 20 μL of 1 M NaPF₆ 0.2 M NaNO₃/5:1 tetraglyme:diglyme (v/v) as an anolyte. The cells with the TFSI membranes utilized a Celgard 3501 interlayer between the Na metal and membrane to improve mechanical stability.

Cell cycling of Example 1 (TFSI 100) and Example 2 (TFSI 90) at current densities of 50 to 800 μA/cm² revealed that the samples had stable cycling in the range of 50 to 200 μA/cm² and spikes in the overpotential at 500 μA/cm². The Comparative Example (Nafion™) also exhibited unstable cycling upon reaching a current density of 500 μA/cm². Extended stripping/plating evaluation was performed at 100 μA/cm². One difference in the cycling profile of the Comparative Example compared to Examples 1 and 2 was the increase in overpotential over time for the Comparative Example. The increase may be due to the instability of Nafion™ against sodium metal, causing a resistive solid-electrolyte interface layer to be formed, which suggests that the non-perfluorinated hydrocarbon membranes of the Examples are more electrochemically stable against sodium metal.

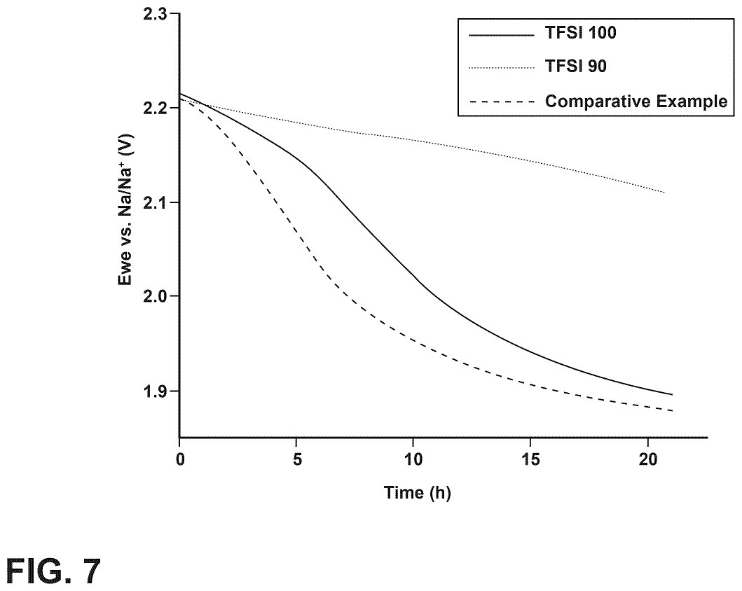

Crossover of polysulfide species (Na₂Sₓ) through the membranes were monitored by a self-discharge process in which Na₂S₈ crosses through the membranes and is reduced at the anode to form insoluble products. Na₂S, which is insoluble in diglyme, is the expected thermodynamic endpoint for such reactions. As shown in FIG. 7, in a full cell assembly the open circuit voltage (E_{we}) decayed over time for all three membranes, though the membranes of Examples 1 and 2 exhibited improved blocking of polysulfide crossover compared to the Comparative Example. Although the Comparative Example had low electrolyte uptake in comparison to the Examples 1 and 2, it had the highest crossover with an OCV of 1.95 V at 10 hours.

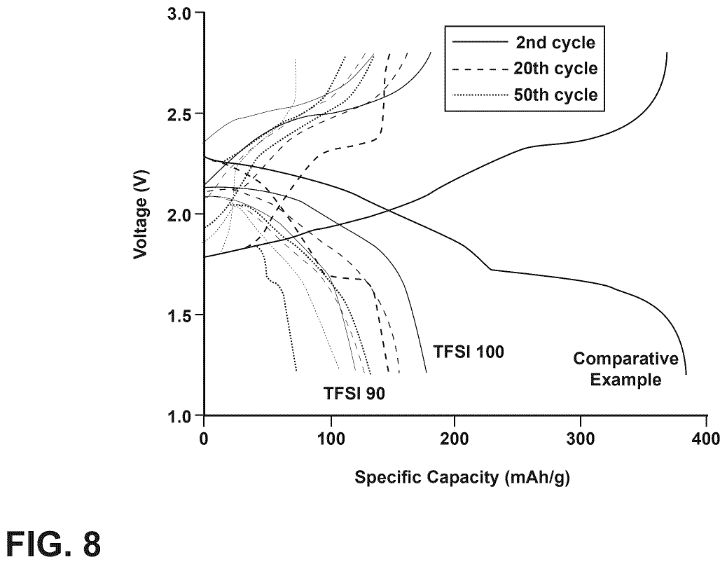

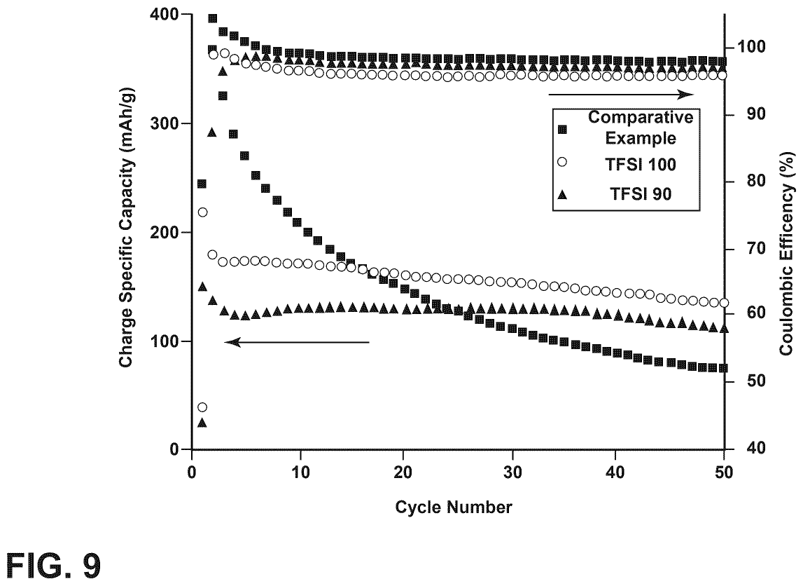

The full cell performance of the membranes was further evaluated in a coin cell configuration. A Celgard interlayer was added between the Na metal and the membranes to enhance the mechanical stability of the membranes during cell assembly. The galvanostatic cycling profiles of the Na—Na₂Sₓ cells at various cycles are shown in FIG. 8. The Comparative Example had the largest initial capacity compared to Examples 1 and 2, but the capacity quickly faded to a level below that of Examples 1 and 2. As shown in FIG. 9, the capacity retention of Examples 1 and 2 significantly outperformed that of the Comparative Example. More specifically, the capacity retention of Example 1 was 62% and of Example 2 was 75%, which was in sharp contrast to that of the Comparative Example at 18%.

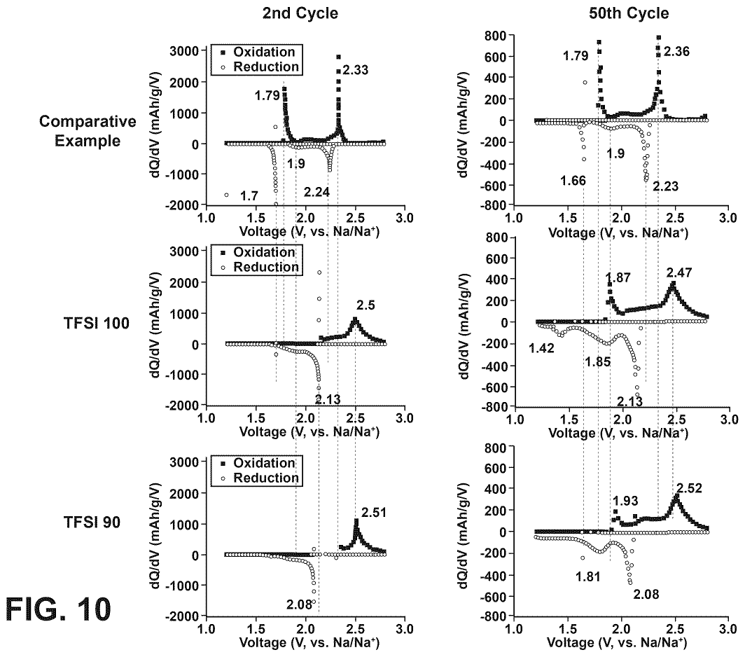

The galvanostatic cycling of the full cells depicted as differential capacity plots in FIG. 10 demonstrated the influence of membrane composition on the polysulfide transition kinetics. To study a full transition cycle of the sodium polysulfide, the 2nd cycle of each sample was examined, as the starting catholyte is Na₂S₈ which has an open circuit voltage (2.21 V) intermediate in the cycling window. Typically, reduction peaks close to 1.65 V and 2.2 V represent a liquid-solid and solid-liquid transition, respectively. In the 2nd cycle, the Comparative Example exhibited the highest reduction peak at 2.24 V, representing a lower energy barrier for the solid S to liquid Na₂S₈ transition. Also, the Na—Na₂Sₓ cell with the Comparative Example exhibited a sharp reduction peak at 1.7 V, corresponding to the transition from sparingly soluble Na₂S₄ to insoluble Na₂Sₓ (x<4). Such a peak is absent for the Example 1 and Example 2 membranes. Clearly, the liquid-solid transition is lacking for the Example 1 and Example 2 samples. In the 50th cycle, additional reduction peaks become more distinguished for Example 1 and Example 2 at 1.85 V and 1.81 V, respectively, corresponding to the transition between Na₂S₈ and Na₂S₅. Overall, compared with the Comparative Example, the polysulfide catholyte with the Example 1 and Example 2 membranes mainly involved the liquid-liquid transition regime.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A hydrocarbon-based membrane material composition for a redox flow battery, the membrane material composition comprising:
component A that is a polymer including an anionic group selected from a group consisting of a sulfonylimide moiety, a tetrahedral borate-based moiety, and a carboxylate-based moiety; and
component B that is a polymer including a sulfonate moiety;
wherein a content of component A is 60 to 100 wt. % based on a total weight of components A and B;
wherein a content of component B is 0 to 40 wt. % based on the total weight of components A and B.

2. The membrane material composition of claim 1, wherein:
the content of component A is 90 to 100 wt. % based on the total weight of components A and B; and
the content of component B is 0 to 10 wt. % based on the total weight of components A and B.

3. The membrane material composition of claim 1, wherein component A is a block copolymer and component B is a block copolymer.

4. The membrane material composition of claim 3, wherein one of:
i) the block copolymer of component A is a pentablock terpolymer;
ii) the block copolymer of component B is a pentablock terpolymer; or
iii) both i) and ii).

5. The membrane material composition of claim 4, wherein the pentablock terpolymer of component A is poly(t-butylstyrene-b-hydrogenated isoprene-b-sulfonylimide styrene-b-hydrogenated isoprene-b-t-butylstyrene).

6. The membrane material composition of claim 4, wherein the pentablock terpolymer of component B is poly(t-butylstyrene-b-hydrogenated isoprene-b-sulfonated styrene-b-hydrogenated isoprene-b-t-butylstyrene).

7. The membrane material composition of claim 1, wherein component A includes a sulfonylimide that is (trifluoromethanesulfonyl)imide.

8. A method of making a hydrocarbon-based membrane for a redox flow battery, the method comprising the steps of:
dissolving the hydrocarbon-based membrane material composition of claim 1 in a solvent to obtain a mixture;
tape casting the mixture on a substrate to obtain a tape-casted product;
annealing the tape-casted product to obtain an annealed product; and
soaking the annealed product in an aqueous base.

9. The method of claim 8, wherein in the annealed product, the block copolymers of components A and B are crosslinked.

10. The method of claim 8, wherein annealing is performed at a temperature in a range of from 100 to 140° C.

11. The method of claim 8, wherein the solvent is a mixture of toluene and 1-propanol.

12. The method of claim 11, wherein toluene and 1-propanol are mixed at a ratio in a range of from 1:0 to 1:1 by weight.

13. The method of claim 8, wherein the base includes one of a sodium cation and a lithium cation.

14. A redox flow battery comprising:
a hydrocarbon-based membrane including:
component A that is a polymer including an anionic group selected from a group consisting of a sulfonylimide moiety, a tetrahedral borate-based moiety, and a carboxylate-based moiety; and
component B that is a polymer including a sulfonate moiety;
wherein a content of component A is 60 to 100 wt. % based on a total weight of components A and B;
wherein a content of component B is 0 to 40 wt. % based on the total weight of components A and B
wherein component A and component B are crosslinked.

15. The redox flow battery of claim 14, wherein component A is a block copolymer and component B is a block copolymer.

16. The redox flow battery of claim 14, wherein the battery is a non-aqueous Na—S flow battery.

17. The redox flow battery of claim 14, further comprising an electrolyte that includes a glyme-based solvent.

18. The redox flow battery of claim 17, wherein the glyme-based solvent includes one or more of a monoglyme, a diglyme, a triglyme, and a tetraglyme.

19. The redox flow battery of claim 17, further comprising at least one sodium-containing salt dispersed within the glyme-based solvent.

20. The redox flow battery of claim 19, wherein the at least one sodium-containing salt includes one or more of sodium hexafluorophosphate, sodium bis(trifluoromethanesulfonyl)imide, sodium bis(fluorosulfonyl)imide, sodium perchlorate, and sodium nitrate.
